(19) United States
(12) Patent Application Publication
(10) Pub. No.: US 2007/0047776 A1
(43) Pub. Date: Mar. 1, 2007

(54) Authentication method, authentication system, program and computer readable information recording medium

(75) Inventor: Tsuneo Mizuno, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/285,092

(22) Filed: Nov. 23, 2005

(30) Foreign Application Priority Data
Aug. 30, 2005 (JP) 2005-249343

(51) Int. Cl. G06K 9/00

(52) U.S. Cl. 382/124

(57) ABSTRACT

An authentication method comprising the step of designating a finger to apply for fingerprint authentication.

### BACKGROUND OF THE INVENTION

1. Field of the Invention

The present invention relates to an authentication method, an authentication system, a program and a computer readable information recording medium, and, in particular, to an authentication method and an authentication system applying fingerprints, a program for operating a computer to carry out the authentication method, and a computer readable information recording medium storing the program.

2. Description of the Related Art

In an information processing apparatus, among various methods for avoiding operation thereof by an unauthorized person, a fingerprint authentication system has been spreading widely as one to be applied for this purpose since the apparatus therefor can be made small-sized, authentication operation can be made easier, and also, the apparatus can be made not so expensive.

Fingerprint authentication belongs to a so-called biometrics field. In this method, a predetermined sensor is applied, features of a user's fingerprint are extracted, the thus-obtained features are compared with those previously registered for an authorized user, and, when the comparison results in agreement, the user is authenticated.

Bio-information such as a fingerprint inherently belongs to a person himself or herself, and thus, with the use thereof, a high-grade security system can be established in which stealing of authentication information can be effectively avoided.

However, since fingerprints are made of information of shapes of skin surfaces of fingertips, a leakage of the fingerprint information may not be completely avoided. Assuming a possible leakage of fingerprint information, a security system applying the information may not become a completely safe system. In fact, if fingerprint information is illegally produced or forged, illegal authentication by a person other than an authorized person himself or herself may be easily achieved. Forged fingerprint information is referred to as an ‘artificial finger’, hereinafter.

Japanese Laid-open Patent Applications Nos. 2004-102446, 2005-044179, 11-073506 and 2001-291103 disclose the prior arts.

### SUMMARY OF THE INVENTION

The present invention has been devised in consideration of the above-mentioned problem, and an object of the present invention is to provide an authentication system by which illegal authentication with the use of an artificial finger or such can be avoided, and a security level can be effectively improved

According to the present invention, a step is provided of designating a specific finger from among those which a person has to apply for authentication.

In this configuration, a specific finger to apply for authentication is thus designated. If an unauthorized person who intends to try illegal authentication has an artificial finger having fingerprint information of an authorized person, a possibility that the fingerprint information of the unauthorized person by accident agrees with that of the finger type, which the authorized person has thus designated to apply for authentication, can be effectively reduced. Accordingly, security of an authentication system can be effectively improved.

### BRIEF DESCRIPTION OF THE DRAWINGS

Other objects and further features of the present invention will become more apparent from the following detailed description when read in conjunction with the accompanying drawings:

FIG. 1 shows a block diagram illustrating a configuration of one embodiment of the present invention;

FIG. 2 shows a flow chart illustrating operation for registration in the embodiment of the present invention;

FIG. 3 shows a flow chart illustrating operation for authentication in the embodiment of the present invention;

FIG. 4 shows a flow chart illustrating details of a fingerprint authentication process inputting step shown in FIG. 3;

FIG. 5 shows a flow chart illustrating details of a fingerprint detecting step shown in FIG. 3;

FIG. 6 shows a flow chart illustrating details of an authentication step and a result outputting step shown in FIG. 3;

FIG. 7 shows an example of a configuration of authentication registration data applicable in the embodiment of the present invention;

FIG. 8 illustrates details of a ‘fingerprint information/finger type’ item shown in FIG. 7;

FIG. 9 shows one example of detected fingerprint information storing data for respective times of trial operations applicable in the embodiment of the present invention; and

FIG. 10 shows one example of a computer by which each of a registration apparatus and an authentication apparatus shown in FIG. 1 may be realized.

### DETAILED DESCRIPTION OF THE PREFERRED EMBODIMENT

A basic concept of an embodiment of the present invention is described first.

Upon fingerprint detection with the use of a fingerprint sensor, a fingerprint is detected by the sensor when a finger of a person to be authenticated is placed on the sensor for a case where the sensor is a flat type, for example. Then, when the detection result agrees with registered information, the authentication process results in success.

Accordingly, if an artificial finger is used, authentication may illegally result in success even for an unauthorized person who uses the artificial finger.

The present invention provides an authentication system with so high security that, even when an artificial finger is used by another person, authentication cannot illegally result in success.

According to the embodiment of the present invention, a fingerprint of any finger, selected from among the total ten fingers, i.e., a thumb, an index finger, a middle finger, a third finger and a little finger of each of a left and a right hands, each person has, is previously designated and registered. Another person, who tries to carry out illegal authentication with the use of an artificial finger, has no idea as to a specific finger type, of which a fingerprint has been registered for a target authorized person. Therefore, a possibility that the other unauthorized person can succeed illegal authentication with the use of the artificial finger can be effectively reduced. Thus, it is possible to effectively improve security of an authentication system. That is, even when another person has an artificial finger, illegal authentication may not result in success unless a finger type of the target artificial finger, or a specific finger of the target authorized person, from which the artificial finger has been produced, coincides by accident with the finger type which the authorized person has previously registered for authentication, or a specific finger, from which a fingerprint has been registered by the authorized person for authentication.

However, even when this method is applied, illegal authentication may result in success with a probability of 1/10 corresponding to the number 10, which is the total number of the fingers each person has as mentioned above.

According to the embodiment of the present invention, in order to eliminate this possibility, the following method may be applied.

That is, upon authentication, a plurality of times of fingerprint trial operations are carried out for each time of authentication. That is, when a person tries to make authentication of himself or herself, the person applies his or per finger to a fingerprint sensor a plurality of times, the number of which is previously registered.

In this case, the person can switch a finger to actually apply to the sensor from one to another, selected from among the total ten fingers of himself or herself, in the respective times of the predetermined number of times of trial operations. For example, assuming that the predetermined number of times of trial operations registered is 5, the person can switch a finger to actually apply to the sensor each trial time. Therefore, for example, the person may apply different five fingers from among the total ten fingers of himself or herself for the above-mentioned respective five times of trial operations. Alternatively, the person may apply the same finger to each of all five times of trial operations.

Further, the user should previously register any one of the above-mentioned previously registered number of times of trial operations, to actually apply for authentication.

As a result, when an unauthorized person uses an artificial finger for illegal authentication, even if the unauthorized person, by accident with a probability of 1/10, has an artificial finger of a finger type coincident with that the authorized person has registered a fingerprint thereof, the unauthorized person does not have the registered information indicating which one of the above-mentioned number of times of trial operations has been registered to actually apply for true authentication. As a result, security of an authentication system can be further improved.

However, even when this method is applied, illegal authentication process results in success if the unauthorized person applies the artificial finger each time of the plurality of times of trail operations, whereby the artificial finger may also be applied for the registered one of the predetermined times of trial operations accordingly.

In order to avoid such a situation, a provision should be made, for example, such that, when same fingerprint information is detected at each of a plurality of ones of the predetermined times of trial operations, the authentication should result in failure.

As a result, the person who tries to carry out illegal authentication with the use of an artificial finger cannot help but apply different fingerprint information for each of the predetermined number of times of trial operations. Accordingly, a probability that the artificial finger is by accident applied for the registered one of the predetermined number of times of trial operations becomes 1/5, assuming that the number of the predetermined number of times of trial operations is 5. Thus, security can be ensured.

Furthermore, the same as in a common authentication system, an allowable number of authentication failure times may be limited to 3, for example. As a result, even when the unauthorized person applies a so-called try-and-error manner, i.e., to use the artificial finger for different one of the plurality of number of times of trial operations in each of a plurality of authentication operations, which may be carried out each time the authentication process results in failure, a probability that illegal authentication by accident results in success can be effectively reduced.

In order to further improve a security level, the following configuration may be preferably provided.

That is, when an authentication process results in failure, for example as a result of an artificial finger being applied, this matter is notified of, to the authorized person.

Specifically, when the registered fingerprint information is detected at a time of trial operation different from the registered one, this matter is notified of to the authorized person (i.e., an ‘alarm output’, described later). The, the authorized person who has received this notification can recognize that an artificial finger of himself or herself has been produced. Then, the authorized person may take a countermeasure to change the registered fingerprint information to one of another finger type, for example.

An authorized person may previously register own respective fingerprints of a plurality of different fingers, and may register the different finger types for the plurality of different ones of the predetermined number of times of trial operations, respectively.

A specific configuration of a fingerprint authentication system in the embodiment of the present invention is described next.

The fingerprint authentication system has such a feature such that, as a hardware configuration thereof, a fingerprint authentication system in the prior art may be applied as it is. That is, the total of the predetermined number of times of trial operations, i.e., fingerprint detecting operations, and a ‘trial time to apply’, which is one of the predetermined number of times of trial operations, i.e., fingerprint detecting operations, for which a designated finger is applied, are previously set as a ‘fingerprint authentication process’. Then, software is configured such that, authentication is made to result in success only when fingerprint information of the registered finger type is detected at the designated ‘trial time to apply’, upon actual authentication.

A procedure of thus designating and registering the total of the predetermined number of times of trial operations, i.e., fingerprint detecting operations and the ‘trial time to apply’ (the above-mentioned total of the predetermined number of times of trial operations and the ‘trial time to apply’ is referred to as a ‘fingerprint authentication process’ as mentioned above, hereinafter) may be carried out at a time of registration in the relevant fingerprint authentication system, or may be carried out at a time of actually carrying out authentication. An example where the fingerprint authentication process is designated and registered at a time of actual authentication is described below.

For example, for a case where a user registers fingerprint information of a ‘right middle finger’, the user designates the ‘right middle finger’ as a finger type at a finger designation step first upon authentication. Then, in a subsequent step, the user designates a total of the predetermined number of times of trial operations and a trial time to apply as the fingerprint authentication process. At this time, any one of the predetermined number of times of trial operations can be set as a trial time to apply for which the designated finger is actually applied.

Specifically, for example, upon authentication, after designating the registered right middle finger, the user sets ‘five times’ as the total of the predetermined number of times of trial operations. Further, the user designates a ‘second time’ and a ‘fifth time’, as the ‘trial times to apply’, as well as the designated finger, i.e., the ‘right middle finger’.

In such a case, the user should preferably apply any other fingers, than the right middle finger, for the others of the predetermined number of times of trial operations, than the designated ones (second and fifth times), i.e., a first time, a third time and a fourth time. By behaving so, the user can camouflage the authentication operation, apparently as if the user apply fingers randomly, for another person who may have an artificial finger. Thereby, the other person who may have an artificial finger becomes difficult to duplicate the authentication procedure of the target authorized user).

It is noted that, registration of fingerprint information should not be limited to carrying out the same only for a single finger. That is, fingerprint information may be registered for each of a plurality of respective fingers, and any one thereof may be designated at a time of authentication.

As a method to achieve higher security, a method of camouflaging a registered finger on purpose is described below.

That is, when a user registers own fingerprint information of a ‘right middle finger’ for example, the user may register another finger, e.g. a ‘right index finger’ or a ‘left middle finger’ as a corresponding finger type, different from the above-mentioned ‘right middle finger, for which the fingerprint information is actually registered. As a result, if only information of the thus-registered finger type leaks to another person, who then produces an artificial finger of the target user according to the thus-obtained information of the registered finger type, i.e., an artificial finger of the ‘right index finer’ or the ‘left middle finger’ of the target user, this person who thus attempts to carry out illegal authentication with the use of the artificial finger cannot succeed upon fingerprint identification since the actual registered fingerprint information corresponds to the ‘right middle finger’, different from the ‘right index finger’ or the ‘left middle finger’, as mentioned above. Thus, a security level can be effectively improved.

Thus, according to the embodiment of the present invention, protection against an attack if any with the use of an artificial finger, with a simple method at a low cost.

Below, a specific configuration of the fingerprint authentication system in the embodiment of the present invention is described with reference to figures.

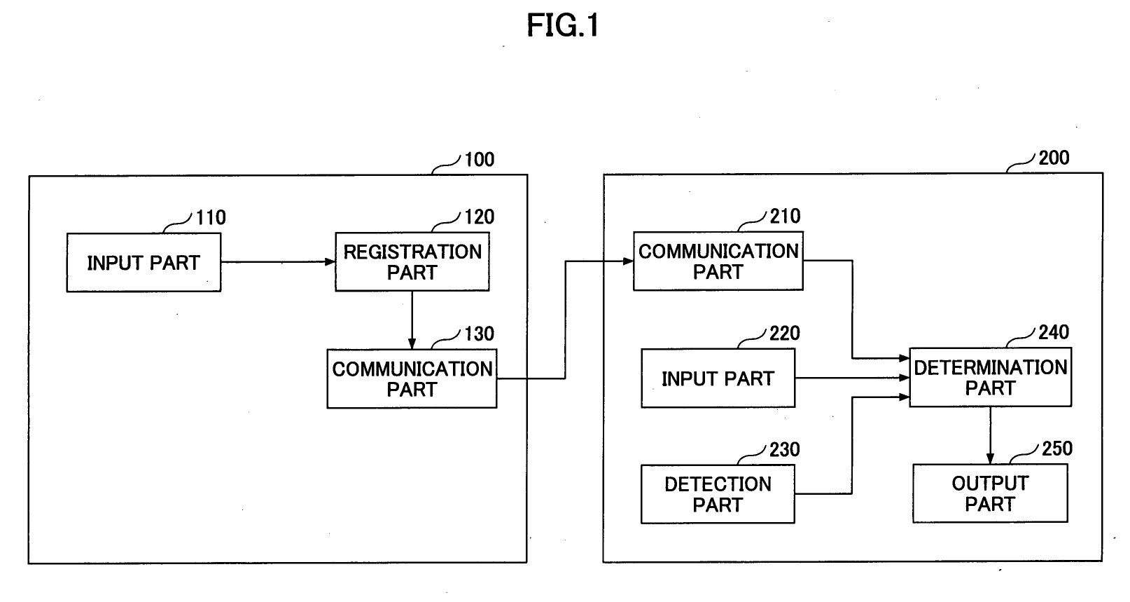

FIG. 1 shows a block diagram of a general configuration of the fingerprint authentication system in the embodiment of the present invention.

As shown, the fingerprint authentication system includes a registration apparatus 100 and an authentication apparatus 200.

The registration apparatus 100 includes an input part 110 for a user to input registration information; a registration part 120 which carries out registration processing for the user based on the thus-input information; and a communication part 130 carrying out communication of the registered contents with the authentication apparatus 200.

The authentication apparatus 200 has a communication part 210 ‘carrying out communication of the registered contents with the registration apparatus 100; an input part 220 for a user to input predetermined information in order to get authentication; a detection part 230 carrying out actual fingerprint detection; a determination part 240 carrying out authentication for the user based the fingerprint information detected by the detection part 230; and an output part 250 outputting the determination result of the determination part 240.

A fingerprint authentication in an embodiment of the present invention is not limited to this configuration. For example, a configuration in which the registration apparatus 100 and the authentication apparatus 200 are integrated in a single apparatus, may be applied. In this case, the communication parts 130 and 210 may be omitted, and the input parts 110 and 210 may be configured as a single common unit.

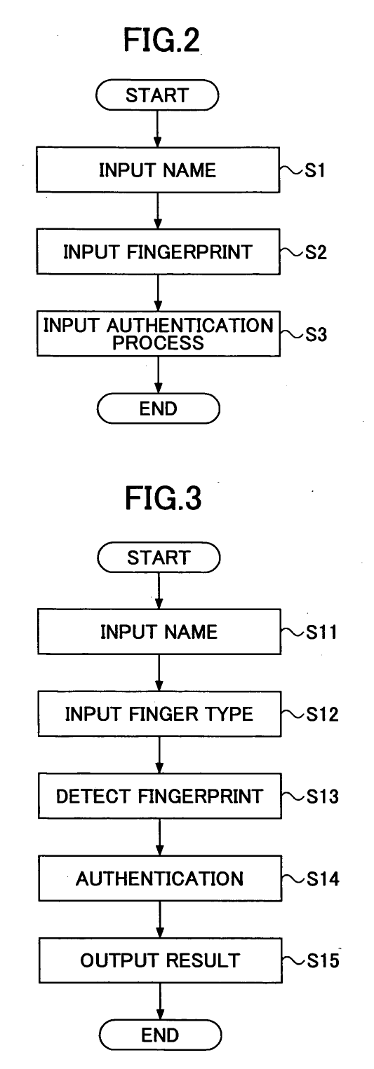

Registration processing of the fingerprint authentication system described above is described now with reference to FIG. 2.

In an example described below, different from the above-mentioned example, designation of the ‘fingerprint authentication process’ is carried out at a time of registration. Designation of the fingerprint authentication process, i.e., designation of a total of the predetermined number of times of trial operations and a trial time to apply, may be carried out at the same time as a resignation of fingerprint information itself. Further, the once designated and registered fingerprint authentication process may be arbitrarily changed or updated after that.

In Step S1 of FIG. 2, a name of an authorized user is input via the input part 110 shown in FIG. 1. The registration part 120 then registers it.

In Step S2, also with the use of the input part 110 and the registration part 120, fingerprint information is input for each of any plurality of fingers, from among those of the authenticated user, and the thus-obtained fingerprint information is registered with a connection to the corresponding respective finger types.

In Step S3, also with the use of the input part 110 and the registration part 120, the above-mentioned fingerprint authentication process is input and registered.

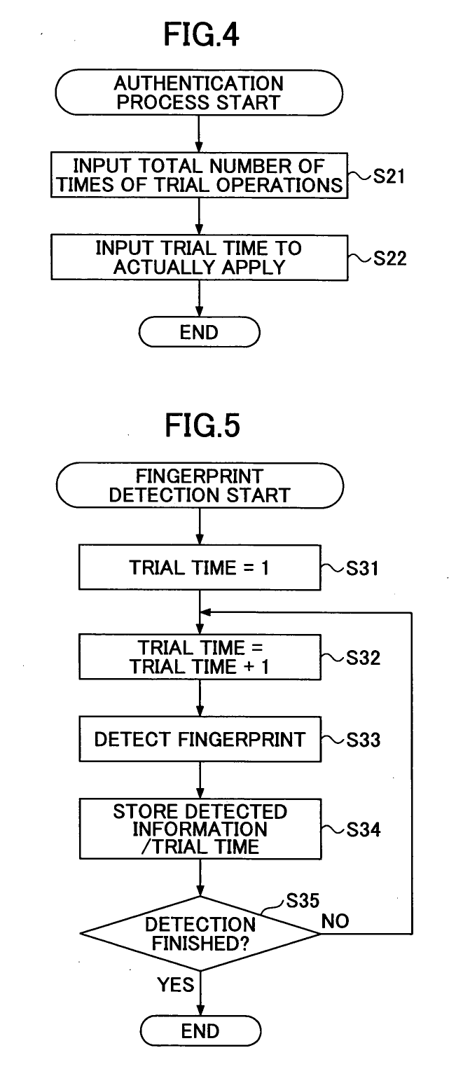

The step of inputting and registering the fingerprint authentication process includes specific steps described next with reference to FIG. 4.

That is, in Step S21 of FIG. 4, a total of the predetermined number of times of trial operations is designated.

In Step S22, a trial time to apply, selected from among the respective ones of the total of the predetermined number of times of trial operations, for which the designated finger is applied.

Next, with reference to FIG. 3, operation carried out upon authentication is described.

In Step S11, a user who wishes to get authentication inputs his or her name via the input part 220.

In Step S12, the user inputs a finger type to apply for authentication via the input part 220. That is, the user selects any one of the finger types, for which the fingerprint information has been previously registered in Step S2 of FIG. 2, and inputs it for designation at this occasion.

In Step S13, a fingerprint of the user is detected via the detection part 230. At this time, the user applies each of own fingers to a fingerprint sensor of the detection part 230, a plurality of times in sequence, while a finger type to apply may be changed each time, in such a manner as to at least apply the finger of the finger type, previously designated in Step S12, for the ‘trial time to apply’ previously designated in Step S22 of the fingerprint authentication process registration in Step S3 of FIG. 2. That is, the user carries out a plurality of times of fingerprint detection trials. At this time, the user carries out the fingerprint detection trials for the total of the predetermined number of times of trial operations, designated in Step S21 of the above-mentioned fingerprint authentication process registration.

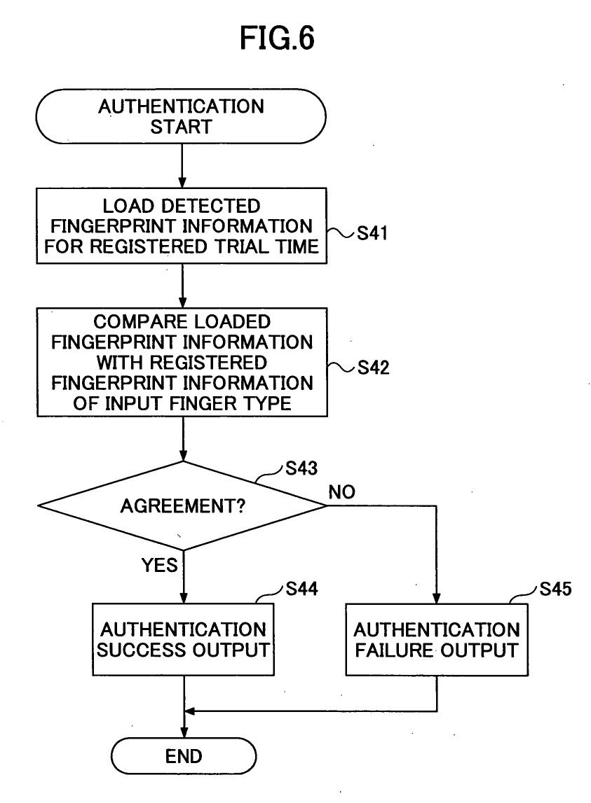

In Step S14, the determination part 240 carries out authentication determination. That is, when the detection result obtained in Step S13 agrees with the fingerprint authentication process (Step S3) of the above-mentioned registration process, the authentication process results in success. In this case, an authentication success output (Step S44 of FIG. 6) described later is made by the output part 250.

It is noted that the information registered as the above-mentioned fingerprint authentication process is transmitted from the registration apparatus 100 via the communication part 130, which is then received by the authentication apparatus 200 via the communication part 210. As a result, this information is transferred to the determination part 240 which then applies it for the above-mentioned authentication determination.

However, when the process where the fingerprint is thus detected in Step S13 does not correspond to the previously registered fingerprint authentication process even when the fingerprint identification process results in success, the authentication process results in failure in the determination part 240 since this state indicates a possibility that an artificial finger is used. Then, an authentication failure output is made by the output part 250 in Step S45.

Also when a different fingerprint is detected there or when no success results from the designated trial time of fingerprint identification process, an authentication failure output is made by the output part 250 in Step S45.

Then, when such an authentication failure output is made continuously for three times for example, the determination part 240 does not further carry out authentication determination operation after that. Further, when a trial time at which fingerprint has been detected does not coincide with the designated trial time to apply even if the correct fingerprint has been detected, or when another fingerprint is detected at the designated trial time to apply, a predetermined ‘alarm output’, mentioned above, is carried out, since such a state indicates a possibility that an artificial finger is used.

With reference to FIG. 5, details of the fingerprint detecting step (S13) are described.

In Step S31, the determination part 240 initializes a ‘trial time’ variable in 1.

In Step S32, the determination part 240 adds 1 to the ‘trial time’ variable.

In Step S33, the detection part 230 carries out actual fingerprint detection through the fingerprint sensor.

In Step S34, the determination part 240 stores fingerprint information thus obtained by the detection part 230, with a connection to the ‘trial time’ variable.

In Step S35, the determination part 240 determines whether or not the detecting processing is finished.

That is, the detection part 240 determines whether or not the total of the predetermined number of times of trial operations designated and registered as the fingerprint authentication process agrees with the ‘trial time’ variable. Then, when they agree with one another, the detecting operation is finished, while, when they do not agree with one another, operation the same as the above is repeated from Step S32 for a subsequent value of the ‘trial time’ variable.

With reference to FIG. 6, the authentication step of Step S14 and the output step (Step S15) of FIG. 3 are described.

In Step S41, the detected fingerprint information stored for the ‘trial time to apply’, designated and registered as the above-mentioned fingerprint authentication process, is extracted from those stored in Step S34, and is loaded.

In Step S42, the determination part 240 compares the thus-loaded fingerprint detected information with the registered fingerprint information previously registered in Step S2 of FIG. 2 for the finger type designated in Step S12 of FIG. 3.

When the comparison result of Step S42 indicates an ‘agreement’, an authentication success output is made in Step S44. On the other hand, when the comparison result indicates a ‘disagreement’, an authentication failure output is made in Step S45.

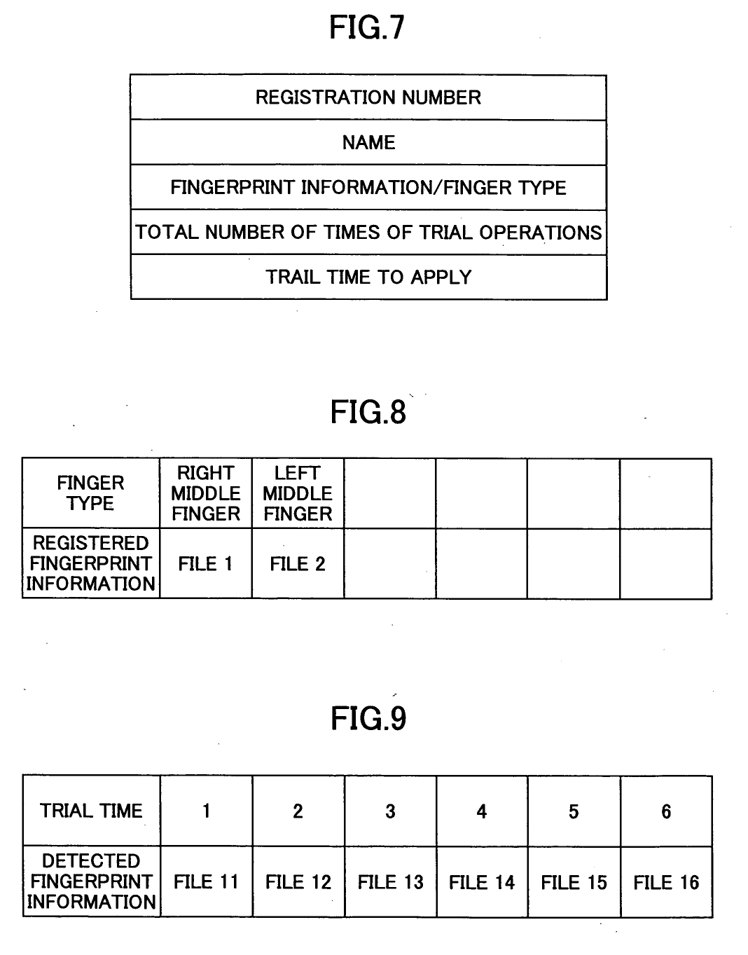

With reference to FIG. 7, an example of authentication registration data according to the present embodiment of the present invention is described next.

The authentication registration data is data registered by the operation of registration, described above with reference to FIG. 2.

As shown in FIG. 7, the authentication registration data includes a ‘registration number’, a ‘name of a registrant’ (‘NAME’), a ‘fingerprint information of the registrant’ (‘FINGERPRINT INFORMATION’), a ‘total of the predetermined number of times of trial operations’ (‘TOTAL NUMBER OF TIMES OF TRIAL OPERATIONS’), and a ‘trial time to apply’.

The ‘fingerprint information of the registrant’ is information of a fingerprint itself of the registrant, registered in Step S2 of FIG. 2, and is registered as files 1, 2, . . . , with connections to corresponding finger types as shown in FIG. 8, respectively.

The ‘total of the predetermined number of times of trial operations’ and the ‘trial time to apply’ are information included in the ‘fingerprint authentication process’, which are designated and registered in Steps S21 and S22 of FIG. 4, respectively.

With reference to FIG. 9, an example of detected fingerprint information storing data, storing the fingerprint information detected in the fingerprint detecting step shown in FIG. 5, is described.

The example of FIG. 9 is an example for a case where the ‘total of the predetermined number of times of trial operations’ is ‘6’.

As shown in FIG. 9, with connections to respective values of the ‘trial time’ variable set in Steps S31 and S32 of FIG. 5, information of fingerprints actually detected in Step S33 are stored as respective files 11 through 16 (in Step S34). Then, after that, in the authentication process described above with reference to FIG. 6, the detection result corresponding to the ‘trial time to apply’ previously designated in Step S12 of FIG. 3 is extracted, which is then load and applied for the actual authentication determination in Step S42 of FIG. 6.

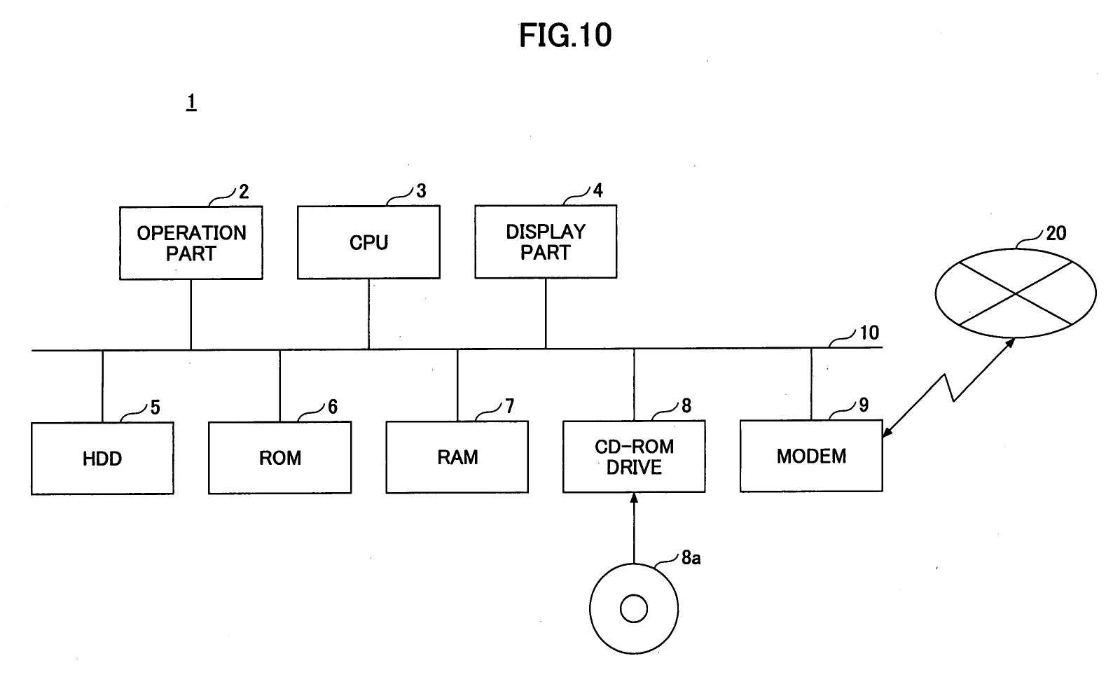

With reference to FIG. 10, a case where the embodiment of the present invention is realized in a computer is described next.

Each of the registration apparatus 100 and the authentication apparatus 200 may be realized by a computer.

The computer includes a CPU 3 carrying out an overall control of entire operation thereof; an operation part 2 for a user to input information; a display part 4 making a display output or a printing output of information for a user; a hard disk drive (HDD) 5 storing various types of information including a program; a ROM 6 and a RAM 7 as memories applied by the CPU 2 upon carrying out various types of operations; a CD-ROM drive 8 for loading a program or such externally; and a modem 9 allowing communication of information externally through a communication network 20 such as the Internet. These parts are connected together by means of a bus 10 so that they can make communication therebetween.

The operation part 2 includes a keyboard, a mouse and so forth, and the display part includes a display device, a printer and so forth.

Although not shown, the fingerprint sensor of the detection part 230 of FIG. 1 is also connected to the bus 10 if necessary.

An example of a correspondence relationship between the computer and the configuration of FIG. 1 is described next.

In FIG. 1, when the computer is applied as the registration apparatus 100, the operation part 2 and the display part 4 operate cooperatively with the CPU 3 as the input part 110, the HDD 5 operates cooperatively with the CPU as the registration part 120 and the modem 9 operates cooperatively with the CPU 3 as the communication part 130.

It is noted that, when a fingerprint is registered in the registration part 120 actually, the fingerprint may be detected directly from a registration target person or a registrant with the use of the fingerprint sensor connected to the computer at the present time, and fingerprint information thus obtained may be then registered. Further, alternatively, fingerprint information previously detected from the relevant person or the registrant may be previously stored in a CD-ROM 8a, and the same may be loaded in the computer via the CD-ROM drive 8 after that.

When the computer is applied as the authentication apparatus 200, the modem 9 operates cooperatively with the CPU 3 as the communication part 210, the operation part 2 and the display part 4 operate cooperatively with the CPU 3 as the input part 220, the CPU 3 operates as the determining part 240, and the display part 4 operates cooperatively with the CPU 3 as the output part 250.

Further, as mentioned above, the fingerprint sensor not shown operates cooperatively with the CPU as the detection part 230.

An example of processing of causing the CPU 3 to execute the authentication method in the embodiment of the present invention described above with reference to FIGS. 1 through 9, or processing of causing the computer to act as the fingerprint authentication system according to the embodiment of the present invention described above with reference to FIGS. 1 through 9, is described next.

That is, first a program is produced which includes instructions for causing the CPU to execute the authentication method in the embodiment of the present invention. Then, this program is recorded in the CD-ROM 8a, which program is then loaded in the computer via the CD-ROM drive 8 with the use of the CD-ROM 8a, or the program is downloaded in the computer via a communication network such as the Internet, or such, from an external server.

The program thus loaded in the computer is stored in the HDD 5, and after that is loaded in the RAM 7 by the CPU 3. Then, the instructions of the program are read from the RAM 7 by the CPU 3, and are thus executed by the computer in sequence. As a result, the authentication method in the embodiment of the present invention is realized, or the computer operates as the fingerprint authentication system in the embodiment of the present invention.

Next, an example in which a fingerprint authentication system according to an embodiment the present invention is applied to a personal computer is described.

A personal computer may be held by a person in some cases (in a form of a notebook type one, for example). Accordingly, a security problem may occur from a possibility that important information may leak when the personal computer is lost. When the above-mentioned fingerprint authentication is applied for solving this problem, a protection against an artificial finger or such as mentioned above should be taken into account. Especially, assuming an authentication method only relying upon a comparison between registered fingerprint information and detected fingerprint information, such a protection may be required.

Designation of the above-mentioned ‘fingerprint authentication process’ may take an important role for this propose as a result of the above-mentioned embodiment of the present invention being applied for this example.

That is, a case is assumed, for example, where, as the fingerprint information, those of a ‘right middle finger’ and a ‘left middle finger’ of a user are registered. Further, as the total of the predetermined number of times of trial operations, ‘five’ is designated, and also, as the trial time to apply, a ‘third time’ is designated.

In this case, first, when a power supply of the personal computer is turned on, a predetermined authentication page is displayed on the personal computer in a log-in stage. In this case, as operation for authentication, the user inputs his or her name by keyboard operation, and inputs a ‘left middle finger’, for example, which is included in those registered as mentioned above, as a finger type to apply. Then, the user causes the personal computer to start a fingerprint detection process with the use of a fingerprint sensor provided therein. Then, at the designated ‘third time’ of trial operation, the user applies the designated ‘left middle finger’ to the fingerprint sensor, while the user applies another finger to the fingerprint sensor for each of times of trial operations other than the designated third time, and thus, the user makes the finger detection trial operations for total ‘five’ times, corresponding to the previously designated number.

It is noted that, the personal computer has a function such that the current log-in trial may result in success only when the fingerprint of the designated finger (i.e., the ‘left middle finger’) is detected for the designated trail time (i.e., ‘third time’). Otherwise, the log-in trial should result in failure and then, a re-trial is allowed. However, when an authentication failure continues for three times for example, predetermined processing, such as automatically turning off the power supply in the personal computer or such, is carried out.

In order to further improve security, the program may be configured such that, once made designation and registration of the above-mentioned fingerprint authentication process may be changed or updated arbitrarily. Thereby, even when an artificial finger is produced, and, at a worst case, information concerning the fingerprint authentication process leaks, illegal authentication can be positively avoided as a result of the fingerprint authentication process, i.e., the total of the predetermined number of times of trial operations and the trial time to apply, being changed or updated periodically, or at appropriate timings. As a result, a security level can be further effectively improved.

The above-described method may be applied to an authentication process made when cash is paid from an ATM of a bank or such, for example.

That is, registration is made for an authorized person in a method the same as that described above applying the fingerprint authentication process. Then after that, the thus-registered fingerprint authentication process is applied actually for authentication for determining whether or not the authorized person himself or herself operates the ATM or such. Then, when the authentication process results in success, cash can be paid from the ATM actually.

In this case, in order to further improve a security level, the Internet, for example, is applied to connect between a personal computer of a home of the user and the bank. Then, at a time of drawing cash from the bank, the user temporarily registers the above-mentioned fingerprint authentication process to apply, by inputting corresponding information to the personal computer, which is then transferred to an information processing terminal of the bank via the Internet, at a current day. That is, the user should temporarily register the fingerprint authentication process only for the current day, and obtain cash from the ATM with the thus-registered fingerprint authentication process after that, within the current day.

By employing such a scheme, even when an unauthorized person, who pretends the authorized person with the use of an artificial finger or such for obtaining cash, illegally obtains the information of the fingerprint authentication process which the authorized person has thus temporarily registered, actual success of illegal authentication with the use of the thus-obtained fingerprint authentication process information can be effectively inhibited since this fingerprint authentication process information is valid only within the current day. Thus, a security level can be effectively improved.

Further, the present invention is not limited to the above-described embodiments, and variations and modifications may be made without departing from the basic concept of the present invention claimed below.

The present application is based on Japanese Priority Application No. 2005-249343, filed on Aug. 30, 2005, the entire contents of which are hereby incorporated herein by reference.

What is claimed is:

1. An authentication method comprising the step of:
a) designating a finger type to apply for fingerprint authentication.

2. The authentication method as claimed in claim 1, further comprising the steps of:
b) registering a fingerprint with a connection to the finger type designated in said step a); and
c) designating a total number of trial times and a specific time, from among said total number of trial times, to actually apply.

3. The authentication method as claimed in claim 1, further comprising the steps of:
b) inputting a finger type;
c) detecting fingerprints for a predetermined number of times; and
d) determining, when the number of times of fingerprint detecting operations in said step c) has reached a previously designated total number of trial times, whether or not a fingerprint registered for the finger type input in said step b) has been detected at a predetermined trial time which is previously designated to actually apply.

4. The authentication method as claimed in claim 2, wherein:
when a fingerprint is registered with a connection to the finger type, the registration is made in such a manner that the finger type having the connection thus made thereto is made different from a true finger type actually corresponding to the thus-registered fingerprint.

5. An authentication system comprising:
a finger designating part configured to designate a finger type to apply for fingerprint authentication.

6. The authentication system as claimed in claim 5, further comprising:
a fingerprint registering part configured to register a fingerprint with a connection to the finger type designated by said finger designating part; and
a total trial number and specific time designating part configured to designate a total number of trial times and a specific time, from among said total number of trial times, to actually apply.

7. The authentication system as claimed in claim 5, further comprising:
a finger type inputting part configured to input a finger type;
a fingerprint detecting part configured to detect fingerprints for a predetermined number of times; and
a determining part configured to determine, when the number of times of fingerprint detecting operations made by said detecting part has reached a previously designated total number of trial times, whether or not a fingerprint registered for the finger type input by said finger type inputting part has been actually detected at a predetermined trial time previously designated to actually apply.

8. The authentication system as claimed in claim 6, wherein:
when a fingerprint is registered with a connection to the finger type, the registration is made in such a manner that the finger type having the connection thus made thereto is made different from a true finger type actually corresponding to the thus-registered fingerprint.

9. A program comprising instructions for operating a computer as a finger designating part configured to designate a finger type to apply for fingerprint authentication.

10. The program as claimed in claim 9, further comprising instructions to operate the computer as:
a fingerprint registering part configured to register a fingerprint with a connection to the finger type; and
a total trial number and specific time designating part configured to designate a total number of trial times and a specific time, from among said total number of trial times, to actually apply.

11. The program as claimed in claim 9, further comprising instructions to operate the computer as:
a finger type inputting part configured to input a finger type;
a fingerprint detecting part configured to detect fingerprints for a predetermined number of times; and
a determining part configured to determine, when the number of times of fingerprint detecting operations made by said detecting part has reached a previously designated total number of trial times, whether or not a fingerprint registered for the finger type input by said finger type inputting part has been detected at a predetermined trial time which is previously designated to actually apply.

12. The program as claimed in claim 10, wherein:
the instructions configured to operate the computer as the fingerprint registering part are configured such that the registration may be made in such a manner that the finger type having the connection thus made thereto is made different from a true finger type actually corresponding to the thus-registered fingerprint.

13. A computer readable information recording medium storing therein the program claimed in claim 9.

14. A computer readable information recording medium storing therein the program claimed in claim 10.

15. A computer readable information recording medium storing therein the program claimed in claim 11.

16. A computer readable information recording medium storing therein the program claimed in claim 12.
